(19) United States
(12) Patent Application Publication
(10) Pub. No.: US 2013/0329007 A1
(43) Pub. Date: Dec. 12, 2013

(54) REDUNDANCY REMOVAL FOR ADVANCED MOTION VECTOR PREDICTION (AMVP) IN THREE-DIMENSIONAL (3D) VIDEO CODING

(71) Applicant: QUALCOMM INCORPORATED, San Diego, CA (US)

(72) Inventors: Li ZHANG, San Diego, CA (US); Ying CHEN, San Diego, CA (US); Marta Karczewicz, San Diego, CA (US)

(73) Assignee: QUALCOMM Incorporated, San Diego, CA (US)

(21) Appl. No.: 13/796,299

(22) Filed: Mar. 12, 2013

Related U.S. Application Data
(60) Provisional application No. 61/656,439, filed on Jun. 6, 2012.

(51) Int. Cl. H04N 7/26

(52) U.S. Cl. CPC H04N 19/00769; H04N 19/00684
USPC 348/43

(57) ABSTRACT

In general, techniques are described for performing motion vector prediction in 3D video coding and, more particularly for managing a candidate list of motion vector predictors (MVPs) for a block of video data. In some examples, a video coder, such as video encoder or video decoder, includes at least three motion vector predictors (MVPs) in a candidate list of MVPs for a current block in a first view of a current access unit of the video data, wherein the at least three MVPs comprise an inter-view motion vector predictor (IVMP), which is a temporal motion vector derived from a block in a second view of the current access unit or a disparity motion vector derived from a disparity vector.

This application claims the benefit of U.S. Provisional Application No. 61/656,439, filed Jun. 6, 2012, the entire content of which is hereby incorporated by reference.

### TECHNICAL FIELD

This disclosure relates to video coding and, more particularly, motion vector prediction in video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal or view (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, techniques are described for performing advanced motion vector prediction (AMVP) for 3D video coding and, more particularly, for managing or constructing a candidate list of motion vector predictors (MVPs) for a block of video data. In some examples, a video coder, such as video encoder or video decoder, includes at least three motion vector predictors (MVPs) in a candidate list of MVPs for a current block in a first view of a current access unit of the video data, wherein the at least three MVPs comprise an inter-view motion vector predictor (IVMP) which is a temporal motion vector derived from a block in a second view of the current access unit or a disparity motion vector derived from a disparity vector.

The video coder may prune redundant, e.g., identical, ones of the at least three MVPs from the candidate list. The candidate list may have a predetermined, fixed length, and there may be more potential candidate MVPs than positions in the candidate list. The example techniques described in this disclosure may reduce the likelihood of redundant MVPs in the candidate list. The example techniques may also increase the likelihood that certain candidate MVPs are included in the list, e.g., by pruning redundant MVPs to make room for the other candidate MVPs.

In one example, a method of coding video data comprises including at least three motion vector predictors (MVPs) in a candidate list of MVPs for a current block in a first view of a current access unit of the video data, wherein the at least three MVPs comprise an inter-view motion vector predictor (IVMP), and wherein the IVMP is one of derived from a block in a second view of the current access unit or converted from a disparity vector for the current block in the first view of the current access unit. The method further comprises when there are one or more redundant MVPs among the at least three MVPs in the candidate list, pruning at least one of the redundant MVPs from the candidate list, coding an index into the candidate list of MVPs, the index referencing one of the MVPs from the candidate list for the current block, and coding the video data based on the one of the MVPs from the candidate list selected for the current block.

In another example, a device comprises a video coder configured to include at least three motion vector predictors (MVPs) in a candidate list of MVPs for a current block in a first view of a current access unit of the video data, wherein the at least three MVPs comprise an inter-view motion vector predictor (IVMP), and wherein the IVMP is one of derived from a block in a second view of the current access unit or converted from a disparity vector for the current block in the first view of the current access unit. The one or more processors are further configured to, when there are one or more redundant MVPs among the at least three MVPs in the candidate list, prune at least one of the redundant MVPs from the candidate list; code an index into the candidate list of MVPs, the index referencing one of the MVPs from the candidate list for the current block, and code the video data based on the one of the MVPs from the candidate list selected for the current block.

In another example, a device comprises means for including at least three motion vector predictors (MVPs) in a candidate list of MVPs for a current block in a first view of a current access unit of the video data, wherein the at least three MVPs comprise an inter-view motion vector predictor (IVMP), and wherein the IVMP is one of derived from a block in a second view of the current access unit or converted from a disparity vector for the current block in the first view of the current access unit. The video coder further comprises means for, when there are one or more redundant MVPs among the at least three MVPs in the candidate list, pruning at least one of the redundant MVPs from the candidate list, means for coding an index into the candidate list of MVPs, the index referencing one of the MVPs from the candidate list for the current block, and means for coding the video data based on the one of the MVPs from the candidate list selected for the current block.

In another example, a computer-readable storage medium has instructions stored thereon that, when executed by one or more processors of a video coder, cause the video coder to include at least three motion vector predictors (MVPs) in a candidate list of MVPs for a current block in a first view of a current access unit of the video data, wherein the at least three MVPs comprise an inter-view motion vector predictor (IVMP), and wherein the IVMP is one of derived from a block in a second view of the current access unit or converted from a disparity vector for the current block in the first view of the current access unit, when there are one or more redundant MVPs among the at least three MVPs in the candidate list, prune at least one of the redundant MVPs from the candidate list, code an index into the candidate list of MVPs, the index referencing one of the MVPs from the candidate list for the current block, and coding the video data based on the one of the MVPs from the candidate list selected for the current block.

In another example, a method of coding video data comprises including, in a first list of motion vector predictors (MVPs) for a current block in a first view of a current access unit of the video data, a first spatial MVP derived from a first spatially-neighboring block to the current block in the first view of the current access unit, and a second spatial MVP derived from a second spatially-neighboring block to the current block in the first view of the current access unit and, when the second spatial MVP is redundant over the first spatial MVP, pruning one of the first and second spatial MVPs from the first list of MVPs. The method further comprises including, in a second list of MVPs for the current block, an inter-view motion vector predictor (IVMP) that is one of derived from a block in a second view of the current access unit or converted from a disparity vector for the current block in the first view of the current access unit, and a temporal motion vector predictor (TMVP) derived from a block in the first view in a previously-coded access unit of the video data and, when the TMVP is redundant over the IVMP, pruning one of the IVMP and TMVP from the second list of MVPs. The method further comprises combining MVPs remaining in the first and second lists to form a candidate list of MVPs, coding an index into the candidate list of MVPs, the index referencing one of the MVPs from the candidate list for the current block, and coding the video data based on the one of the MVPs from the candidate list selected for the current block.

In another example, a method of coding video data comprises including, in a candidate list of motion vector predictors (MVPs) for a current block in a first view of a current access unit of the video data, a first spatial MVP derived from a first spatially-neighboring block to the current block in the first view of the current access unit, and a second spatial MVP derived from a second spatially-neighboring block to the current block in the first view of the current access unit, wherein a predetermined length (N) of the candidate list is equal to two. The method further comprises, when the second spatial MVP is redundant over the first spatial MVP, removing one of the first and second spatial MVPs from the candidate list, and adding an inter-view motion vector predictor (IVMP) that is one of derived from a block in a second view of the current access unit to the candidate list or converted from a disparity vector for the current block in the first view of the current access unit. The method further comprises coding an index into the candidate list of MVPs, the index referencing one of the MVPs from the candidate list for the current block, and coding the video data based on the one of the MVPs from the candidate list selected for the current block

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may be configured to utilize the techniques described in this disclosure for managing a candidate list of motion vector predictors (MVPs) for advanced motion vector prediction (AMVP) in 3D video coding.

FIG. 2 is a conceptual diagram illustrating an example current video block in relation to a plurality of spatially-neighboring blocks from which spatial MVPs for the current block may be derived.

FIG. 3 is a conceptual diagram illustrating an example picture including a current video block, and a temporal reference picture including a reference block from which a temporal motion vector predictor (TMVP) may be derived.

FIG. 4 is a conceptual diagram illustrating example pictures of a plurality of access units, each access unit including a plurality of views, and derivation of an inter-view motion vector predictor (IVMP).

FIG. 5 is a flowchart illustrating an example technique for deriving an MVP candidate list for a current block and coding video data based on an MVP selected from the candidate list.

FIGS. 6-9 are flowcharts illustrating example techniques for managing an MVP candidate list for a current block of video data.

FIG. 10 is a block diagram illustrating an example of a video encoder that may implement the techniques described in this disclosure for managing a candidate list of MVPs.

FIG. 11 is a block diagram illustrating an example of a video decoder that may implement the techniques described in this disclosure for managing a candidate list of MVPs.

### DETAILED DESCRIPTION

The techniques described in this disclosure are generally related to 3D video coding, e.g., the coding of two or more views. More particularly, the techniques are related to 3D video coding using a multiview coding (MVC) process, such as an MVC plus depth process. For example, the techniques may be applied to a 3D-HEVC encoder-decoder (codec) in which MVC or MVC plus depth coding processes are used. An HEVC extension for 3D-HEVC coding processes is currently under development and, as presently proposed, makes use of MVC or MVC plus depth coding processes. Additionally, the techniques described in this disclosure are related to advanced motion vector prediction (AVMP) in the context of 3D video coding, such as the 3D video according to 3D-HEVC. The techniques described herein may be implemented by video codecs configured according to any of a variety of video coding standards, including the standards described in this disclosure.

As one example, the techniques described in this disclosure may be implemented by a High Efficiency Video Coding (HEVC) codec configured to perform 3D-HEVC coding processes, as discussed above. However, other example video coding standards that possibly could be extended or modified for use with the techniques of this disclosure include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. A joint draft of MVC is described in “Advanced video coding for generic audiovisual services,” ITU-T Recommendation H.264, March 2010, which as of Jun. 6, 2012 is downloadable from http://www.itu.int/ITU-T/recommendations/rec.aspx?id=10635.

High Efficiency Video Coding (HEVC) is currently being developed by the Joint Collaboration Team on Video Coding (JCT-VC) of ITU-T Video Coding Experts Group (VCEG) and ISO/IEC Motion Picture Experts Group (MPEG). A recent draft of HEVC is available from: http://wg11.sc29.org/jct/doc_end_user/current_document.php?id=5885/JCTVC-11003-v2. Another recent draft of the HEVC standard, referred to as “HEVC Working Draft 7” is downloadable from: http://phenix.it-sudparis.eu/jct/doc_end_user/documents/9_Geneva/wg11/JCTVC-11003-v3.zip, as of Jun. 6, 2012. The full citation for the HEVC Working Draft 7 is document HCTVC-11003, Bross et al., “High Efficiency Video Coding (HEVC) Text Specification Draft 7,” Joint Collaborative Team on Video Coding (JCT-VC) of ITU-T SG16 WP3 and ISO/IEC JTC1/SC29/WG11, 9^{th} Meeting: Geneva, Switzerland, Apr. 27, 2012 to May 7, 2012.

Examples of the HEVC-based 3D Video Coding (3D-HEVC) codec presently under development by the Motion Pictures Expert Group (MPEG) are described in MPEG documents m22570 and m22571. The latest reference software HM version 3.0 for 3D-HEVC can be downloaded from the following link: https://hevc.hhi.fraunhofer.de/svn/svn 3DVCSoftware/tags/HTM-3.0/. The full citation for m22570 is: Schwarz et al., Description of 3D Video Coding Technology Proposal by Fraunhofer HHI (HEVC compatible configuration A), MPEG Meeting ISO/IEC JTC1/SC29/WG11, Doc. MPEG11/M22570, Geneva, Switzerland, November/December 2011. The full citation for m22571 is: Schwarz et al., Description of 3D Video Technology Proposal by Fraunhofer HHI (HEVC compatible; configuration B), MPEG Meeting—ISO/IEC JTC1/SC29/WG11, Doc. MPEG11/M22571, Geneva, Switzerland, November/December 2011.

Each of the preceding references is incorporated herein by reference in their respective entireties. The techniques described in this disclosure are not limited to these standards, and may be extended to other standards, including standards that rely upon motion vector prediction for video coding.

In general, this disclosure describes techniques for managing or constructing a candidate list of motion vector predictors (MVPs) for a block of video data, e.g., for the performance of advanced motion vector prediction (AMVP) or merge mode. There may be problems with this existing AMVP design, for example, of the currently-proposed 3D-HEVC. As an example of such problems, when a coder operates according to this existing AMVP design of the current 3D-HEVC, identical MVP candidates may be present in the final candidate MVP list, even when there is an available MVP candidate, e.g., a temporal motion vector predictor (TMVP), which is not included in the list, and is different from any candidate in the final candidate MVP list. In such examples, the candidate not included in the final candidate MVP list, e.g., the TMVP candidate, may be a valid, or even preferred option, but will not be available for coding the current block.

The techniques of disclosure may include pruning a candidate MVP list in a manner that may better address redundancy in the candidate list, and better, facilitate inclusion of additional non-redundant candidates in the candidate MVP list, than the existing AMVP design of the currently-proposed 3D-HEVC. In some examples, the techniques of disclosure may include comparison of an inter-view motion vector predictor (IVMP) to other MVPs, e.g., spatial or temporal MVPs, for purposes of pruning the candidate MVP list. In some examples, a video coder, such as video encoder or video decoder, includes at least three motion vector predictors (MVPs) in a candidate list of MVPs for a current block in a first view of a current access unit of the video data, wherein the at least three MVPs comprise an IVMP which is a temporal motion vector derived from a block in a second view of the current access unit or a disparity motion vector derived from a disparity vector.

The video coder may prune redundant, e.g., identical, ones of the at least three MVPs from the candidate list. The candidate list may have a predetermined, fixed length, and there may be more potential candidate MVPs than positions in the candidate list. The example techniques described in this disclosure may reduce the likelihood of redundant MVPs in the candidate list. The example techniques may also increase the likelihood that certain candidate MVPs are included in the list, e.g., by pruning redundant MVPs to make room for the other candidate MVPs.

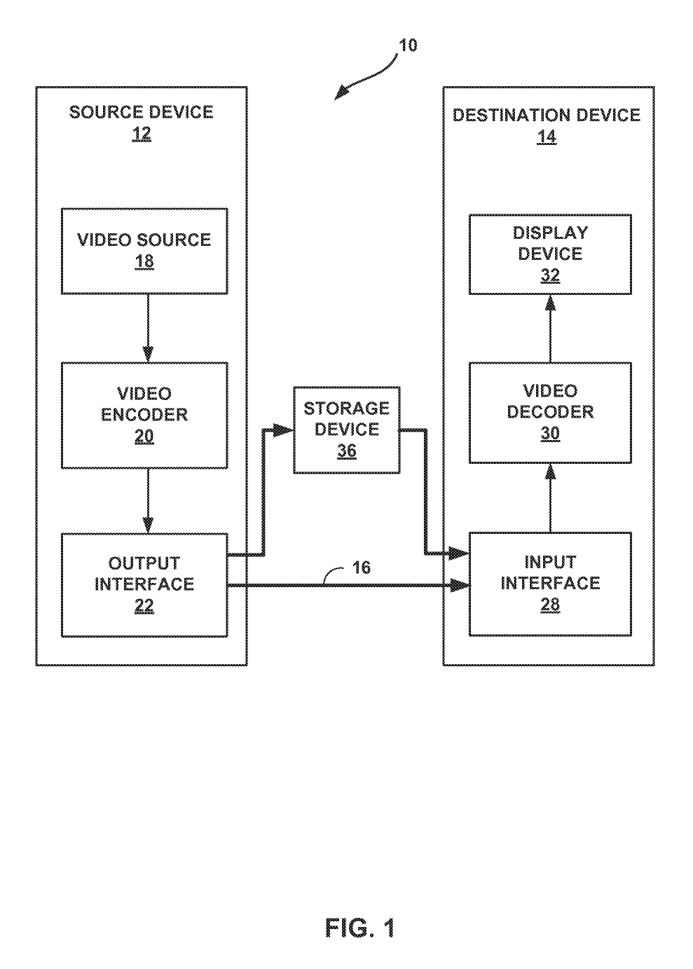

FIG. 1 is a block diagram illustrating an example video encoding and decoding system 10 that may be configured to utilize the techniques described in this disclosure for managing a candidate list of motion vector predictors (MVPs) for advanced motion vector prediction (AMVP) in 3D video coding. As shown in the example of FIG. 1, system 10 includes a source device 12 that generates encoded video for decoding by destination device 14. Source device 12 may transmit the encoded video to destination device 14 via communication channel 16, or may store the encoded video on a storage device 36, e.g., storage medium or file server, such that the encoded video may be accessed by the destination device 14 as desired. Source device 12 and destination device 14 may comprise any of a wide variety of devices, including desktop computers, notebook (i.e., laptop) computers, tablet computers, set-top boxes, telephone handsets (including cellular telephones or handsets and so-called smartphones), televisions, cameras, display devices, digital media players, video gaming consoles, or the like.

In many cases, such devices may be equipped for wireless communication. Hence, communication channel 16 may comprise a wireless channel. Alternatively, communication channel 16 may comprise a wired channel, a combination of wireless and wired channels, or any other type of communication channel or combination of communication channels suitable for transmission of encoded video data, such as a radio frequency (RF) spectrum or one or more physical transmission lines. In some examples, communication channel 16 may form part of a packet-based network, such as a local area network (LAN), a wide-area network (WAN), or a global network such as the Internet. Communication channel 16, therefore, generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

As further shown in the example of FIG. 1, source device 12 includes a video source 18, video encoder 20, and an output interface 22. Video source 18 may include a video capture device. The video capture device, by way of example, may include one or more of a video camera, a video archive containing previously captured video, a video feed interface to receive video from a video content provider, and/or a computer graphics system for generating computer graphics data as the source video. As one example, if video source 18 is a video camera, source device 12 and destination device 14 may form so-called camera phones or video phones, e.g., as in smartphones or tablet computers, or other mobile computing devices. The techniques described in this disclosure, however, are not limited to wireless applications or settings, and may be applied to non-wireless devices including video encoding and/or decoding capabilities. Source device 12 and destination device 14 are, therefore, merely examples of coding devices that can support the techniques described herein.

Video encoder 20 may encode the captured, pre-captured, or computer-generated video, as will be described in greater detail below. Video encoder 20 may output the encoded video to output interface 22, which may provide the encoded video to destination device 14 via communication channel 16. Output interface 22 may, in some examples, include a modulator/demodulator (“modem”) and/or a transmitter.

Output interface 22 may additionally or alternatively provide the captured, pre-captured, or computer-generated video that is encoded by the video encoder 20 to storage device 36 for later retrieval, decoding and consumption. Storage device 36 may include Blu-ray discs, DVDs, CD-ROMs, flash memory, or any other suitable digital storage media for storing encoded video. Destination device 14 may access the encoded video stored on the storage device, decode this encoded video to generate decoded video and playback this decoded video.

Storage device 36 may additionally or alternatively include any type of server capable of storing encoded video and transmitting that encoded video to the destination device 14. Example a file server, a web server (e.g., for a website), an FTP server, network attached storage (NAS) devices, a local disk drive, or any other type of device capable of storing encoded video data and transmitting it to a destination device. The transmission of encoded video data from storage device 36 may be a streaming transmission, a download transmission, or a combination of both. Destination device 14 may access storage device 36 in accordance with any standard data connection, including an Internet connection. This connection may include a wireless channel (e.g., a Wi-Fi connection or wireless cellular data connection), a wired connection (e.g., DSL, cable modem, etc.), a combination of both wired and wireless channels or any other type of communication channel suitable for accessing encoded video data stored on a file server.

Destination device 14, in the example of FIG. 1, includes an input interface 28 for receiving information, including coded video data, a video decoder 30, and a display device 32. The information received by input interface 28 may include a variety of syntax information generated by video encoder 20 for use by video decoder 30 in decoding the associated encoded video data. Each of video encoder 20 and video decoder 30 may form part of a respective encoder-decoder (CODEC) that is capable of encoding or decoding video data.

Display device 32 of destination device 14 represents any type of display capable of presenting video data for consumption by a viewer. Although shown as integrated with destination device 14, display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

As discussed above, the techniques described in this disclosure are generally related to 3D video coding, e.g., involving the coding of two or more texture views and/or view including texture and depth components. In some examples, 3D video coding techniques may use MVC or MVC plus depth processes, e.g., as in the 3D-HEVC standard currently under development. In some examples, the video data encoded by video encoder 20 and decoded by video decoder 30 includes two or more pictures at any given time instance, i.e., within an “access unit,” or data from which two or more pictures at any given time instance can be derived. In some examples, a device, e.g., video source 18, may generate the two or more pictures by, for example, using two or more spatially offset cameras, or other video capture devices, to capture a common scene. Two pictures of the same scene captured simultaneously, or nearly simultaneously, from slightly different horizontal positions can be used to produce a three-dimensional effect. Alternatively, video source 18 (or another component of source device 12) may use depth information or disparity information to generate a second picture of a second view at a given time instance from a first picture of a first view at the given time instance. In this case, a view within an access unit may include a texture component corresponding to a first view and a depth component that can be used, with the texture component, to generate a second view. The depth or disparity information may be determined by a video capture device capturing the first view, or may be calculated, e.g., by video source 18 or another component of source device 12, from video data in the first view.

To present 3D video, display device 32 may simultaneously, or nearly simultaneously, display two pictures associated with different views of a common scene, which were captured simultaneously or nearly simultaneously. In some examples, a user of destination device 14 may wear active glasses to rapidly and alternatively shutter left and right lenses, and display device 32 may rapidly switch between a left view and a right view in synchronization with the active glasses. In other examples, display device 32 may display the two views simultaneously, and the user may wear passive glasses, e.g., with polarized lenses, which filter the views to cause the proper views to pass through to the user's eyes. In other examples, display device 32 may comprise an autostereoscopic display, which does not require glasses for the user to perceive the 3D effect.

Video encoder 20 and video decoder 30 may operate according to any of the video coding standards referred to herein, such as the HEVC standard and the 3D-HEVC extension presently under development. When operating according to the HEVC standard, video encoder 20 and video decoder 30 may conform to the HEVC Test Model (HM). The techniques of this disclosure, however, are not limited to any particular coding standard.

HM refers to a block of video data as a coding unit (CU). In general, a CU has a similar purpose to a macroblock coded according to H.264, except that a CU does not have the size distinction associated with the macroblocks of H.264. Thus, a CU may be split into sub-CUs. In general, references in this disclosure to a CU may refer to a largest coding unit (LCU) of a picture or a sub-CU of an LCU. For example, syntax data within a bitstream may define the LCU, which is a largest coding unit in terms of the number of pixels. An LCU may be split into sub-CUs, and each sub-CU may be split into sub-CUs. Syntax data within a bitstream may define a maximum number of times an LCU may be split, referred to as a maximum CU depth. Accordingly, a bitstream may also define a smallest coding unit (SCU).

An LCU may be associated with a hierarchical quadtree data structure. In general, a quadtree data structure includes one node per CU, where a root node corresponds to the LCU. If a CU is split into four sub-CUs, the node corresponding to the CU includes a reference for each of four nodes that correspond to the sub-CUs. Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs.

A CU that is not split may include one or more prediction units (PUs). In general, a PU represents all or a portion of the corresponding CU, and includes data for coding the block of video data associated with the PU. For example, the PU may include data indicating a prediction mode for coding the associated block of video data, e.g., whether the block is intra-coded or inter-coded. An intra-coded block is coded based on an already-coded block in the same picture. An inter-coded block is coded based on an already-coded block of a different picture. The different picture may be a temporally different picture, i.e., a picture before or after the current picture in a video sequence. Alternatively, in the case of multiview coding, e.g., in 3D-HEVC, the different picture may be a picture that is from the same access unit as the current picture, but associated with a different view than the current picture. In this case, the inter-prediction can be referred to as inter-view coding.

The block of the different picture used for predicting the block of the current picture is identified by a prediction vector. In multiview coding, there are two kinds of prediction vectors. One is a temporal motion vector pointing to a block in a temporal reference picture. The other type of prediction vector is a disparity motion vector, which points to a block in a picture in the same access unit current picture, but of a different view. With a disparity motion vector, the corresponding inter prediction is referred to as disparity-compensated prediction (DCP).

The data defining a motion vector or disparity motion vector may describe, for example, a horizontal component of the motion vector, a vertical component of the motion vector, and a resolution for the motion vector (e.g., integer precision, one-quarter pixel precision or one-eighth pixel precision). The data for the PU may also include data indicating a direction of prediction, i.e., to identify which of reference picture lists L0 and L1 should be used. The data for the PU may also include data indicating a reference picture to which the motion vector or disparity motion vector points, e.g., a reference picture index into a list of reference pictures. Data for the CU defining the PU(s) may also describe, for example, partitioning of the CU into one or more PUs. Partitioning modes may differ between whether the CU is uncoded, intra-prediction mode encoded, or inter-prediction mode encoded.

In addition to having one or more PUs, a CU may include one or more transform units (TUs). Following prediction using a PU, a video encoder may calculate residual values for the portion of the CU corresponding to the PU, where these residual values may also be referred to as residual data. The residual values may comprise pixel difference values, e.g., differences between coded pixels and predictive pixels, where the coded pixels may be associated with a block of pixels to be coded, and the predictive pixels may be associated with one or more blocks of pixels used to predict the coded block. A TU is not necessarily limited to the size of a PU. Thus, TUs may be larger or smaller than corresponding PUs for the same CU. In some examples, the maximum size of a TU may be the size of the corresponding CU. This disclosure uses the term “block” or “video block” to refer to any one or combination of a CU, PU, and/or TU.

To further compress the residual values of a block, the residual values may be transformed into a set of transform coefficients that compact data (also referred to as “energy”) as possible into coefficients. Transform techniques may comprise a discrete cosine transform (DCT) process or conceptually similar process, integer transforms, wavelet transforms, or other types of transforms. The transform converts the residual values of the pixels from the spatial domain to a transform domain. The transform coefficients correspond to a two-dimensional matrix of coefficients that is ordinarily the same size as the original block. In other words, there are just as many transform coefficients as pixels in the original block. However, due to the transform, many of the transform coefficients may have values equal to zero.

Video encoder 20 may then quantize the values of the transform coefficients to further compress the video data. Quantization generally involves mapping values within a relatively large range to values in a relatively small range, thus reducing the amount of data needed to represent the quantized transform coefficients. The quantization process may reduce the bit depth associated with some or all of the coefficients.

Following quantization, video encoder 20 may scan the transform coefficients, producing a one-dimensional vector from the two-dimensional matrix including the quantized transform coefficients. Video encoder 20 may then entropy encode the one-dimensional vector to even further compress the data. In general, entropy coding comprises one or more processes that collectively compress a sequence of quantized transform coefficients and/or other syntax information. Entropy coding may include, as examples, content adaptive variable length coding (CAVLC), context adaptive binary arithmetic coding (CABAC), syntax-based context-adaptive binary arithmetic coding (SBAC), Probability Interval Partitioning Entropy (PIPE) coding, or another entropy encoding methodology.

As discussed above, the data defining a motion vector or disparity motion vector for a block of video data may include horizontal and vertical components of the vector, as well as a resolution for the vector. In other examples, the data defining the motion vector or disparity motion vector may describe the vector in terms of what is referred to as a motion vector predictor (MVP). A MVP for a current PU may be a motion vector of a spatially-neighboring PU, i.e., a PU that is adjacent the current PU being coded. Alternatively, a MVP for a current PU may be a motion vector of a temporally co-located block in another picture. As a further alternative, a MVP for a current PU may be a temporal motion vector derived from a reference block in an interview reference picture (i.e., a reference picture in the same access unit as the current picture, but from a different view), or a disparity motion vector derived from a disparity vector. Typically, a candidate list of MVPs is formed in a defined manner, such as by listing the MVPs starting with those having the least amplitude to those having the greatest amplitude, i.e., least to greatest displacement between the current PU to be coded and the reference PU, or listing the MVPs based on the location of the reference block, e.g., spatially left, spatially above, interview reference picture, or temporal reference picture.

After forming the list of MVPs, video encoder 20 may assess each of the MVPs to determine which provides the best rate and distortion characteristics that best match a given rate and distortion profile selected for encoding the video. Video encoder 20 may perform a rate-distortion optimization (RDO) procedure with respect to each of the MVPs, selecting the one of the MVPs having the best RDO results. Alternatively, video encoder 20 may select one of the MVPs stored to the list that best approximates a motion vector determined for the current PU. In any event, video encoder 20 may specify the selected MVP using an index identifying the selected one of the MVPs in the candidate list of MVPs. Video encoder 20 may signal this index in the encoded bitstream for used by video decoder 30. For coding efficiency, the candidate MVPs may be ordered in the list such that the MVP most likely to be selected is first, or otherwise is associated with the lowest magnitude index value.

According to one technique for using MVPs, video encoder 20 and video decoder may implement what is referred to as a “merge mode.” In general, according to merge mode, a current block, e.g., PU, inherits the prediction vector from another previously-coded block, e.g., a neighboring block, or a block in a temporal or interview reference picture. When implementing the merge mode, video encoder 20 constructs a list of candidate MVPs (reference pictures and motion vectors) in a defined matter, selects one of the candidate MVPs, and signals a candidate list index identifying the selected MVP to video decoder 30 in the bitstream. Video decoder 30, in implementing the merge mode, receives this candidate list index, reconstructs the candidate list of MVPs according to the defined manner, and selects the one of the MVPs in the candidate list indicated by the index. Video decoder 30 then instantiates the selected one of the MVPs as a prediction vector for the current PU at the same resolution of the selected one of the MVPs, and pointing to the same reference picture to which the selected one of the MVPs points. At the decoder side, once the candidate list index is decoded, all of the motion parameters of the corresponding block of the selected candidate are inherited such as, e.g., motion vector, prediction direction, and reference picture index. Merge mode promotes bitstream efficiency by allowing the video encoder 20 to signal an index into the candidate MVP list, rather than all of the information defining a prediction vector.

Another technique by which video encoder 20 and video decoder 30 utilize MVPs is referred to as “advanced motion vector prediction” (AMVP). Similar to merge mode, when implementing AMVP, video encoder 20 constructs a list of candidate MVPs in a defined matter, selects one of the candidate MVPs, and signals a candidate list index identifying the selected MVP to video decoder 30 in the bitstream. Similar to merge mode, when implementing AMVP, video decoder 30 reconstructs the list of candidate MVPs in the defined matter, decodes the candidate list index from the encoder, and selects and instantiates one of the MVPs based on candidate list index.

However, contrary to the merge mode, when implementing AMVP, video encoder 20 also signals a reference picture index, thus specifying the reference picture to which the MVP specified by the candidate list index points. Additionally, for AMVP, both video encoder 20 and video decoder 30 construct the candidate list based on the reference picture index, as described in greater detail below. Further, video encoder 20 determines a motion vector difference (MVD) for the current block, where the MVD is a difference between the MVP and the actual motion vector or disparity motion vector that would otherwise be used for the current block. For AMVP, in addition to the reference picture index and candidate list index, video encoder 20 signals the MVD for the current block in the bitstream. Due to the signaling of the reference picture index and prediction vector difference for a given block, AMVP may not be as efficient as merge mode, but may provide improved fidelity of the coded video data. In general, the techniques described herein are described as being implemented in a coder using AMVP. However, techniques may, in some examples, be applied by a coder using merge mode, or any other mode of using MVPs to represent inter-picture prediction vectors.

To provide even more efficient coding of prediction vectors, the defined manner for constructing candidate list of MVPs employed by video encoder 20 and video decoder 30 may include “pruning,” e.g., removing, redundant MVPs from the list. In some examples, MVPs having the same amplitude on both the X and Y components, and referencing the same reference picture, e.g., identical MVPs, may be considered as redundant MVPs. Pruning may occur by removing one or MVPs from the list of candidate MVPs, and/or by not adding MVPs to the list of candidate MVPs, in various examples. In either case, the pruning process may reduce the size of the list with the result that less bits may need to be used to signal or otherwise specify the selected one of the MVPs, because a shorter list generally requires a smaller number of bits to express the greatest index value. For example, using a truncated unary code to signal the index into the MVP candidate list, the number of bits required to signal the index is directly correlated to the size of the list.

In some examples, video encoder 20 signals the selected candidate MVP using a unary code representative of an index of the selected candidate MVP as arranged in the candidate list constructed according to the defined manner. The defined manner of constructing the candidate list of MVPs may include arranging or ordering the candidate MVPs in a set or defined manner. Video encoder 20 and video decoder 30 may order the MVPs in the candidate list in an order such that the most likely candidate MVP to be selected is first, or otherwise associated with the smallest candidate list index values. Video encoder 20 and video decoder 30 may order the MVPs in the candidate list, as examples: from highest X,Y amplitude to lowest amplitude; lowest amplitude to highest amplitude; spatial MVPs order according to amplitude first, followed by the TMVP and IVMP; or IVMP and TMVP first, followed by spatial MVPs ordered according to amplitude.

To enable video decoder 30 to parse the candidate list index placed in the bitstream by the video encoder, the candidate list of MVPs may have a predefined length, N, which is an integer value, e.g., 1, 2, or 3. If the candidate list includes greater than N MVPs after pruning, the list may be truncated to N candidate MVPs. Accordingly, the order of the candidate MVPs in the candidate list may be significant as one or more candidate MVPs at the end of the list may be more likely to be truncated.

If the candidate list includes less than N MVPs after pruning, one or more zero value MVPs, e.g., prediction vectors whose X and Y values are 0, may be added to the end of the list until the list includes N MVPs. The candidate list may include fewer than N MVPs due to pruning and/or unavailability of one or more MVPs. MVPs may be unavailable when, for example, the spatially-neighboring, temporal, or interview reference blocks were intra-coded. As another example, spatial MVPs may be unavailable when the spatially-neighboring blocks are unavailable due to the position of the current block relative to a picture or slice boundary.

For AMVP as specified in the 3D extension of HEVC (i.e., 3D-HEVC), for example, the length, N, of the MVP candidate list is restricted to 3. The coder, e.g., video encoder 20 or video decoder 30, inserts two spatial MVPs and an IVMP into the candidate list, in order, if available. The IVMP may be a temporal motion vector derived from a block in a second view of the current access unit or a disparity motion vector derived from a disparity vector. If only two of these three MVP candidates are available, and they have the same value, the coder removes the candidate greater magnitude index value in the candidate list. Then, the coder inserts a TMVP into the candidate list, if it is available. If all three of the two spatial MVP candidates and the IVMP candidate are available, regardless of whether they are redundant, the coder will include them in the candidate MVP list, and will not include the TMVP candidate in the list. If the number of valid MVP candidates is less than 3, the coder will insert zero value MVPs into the AMVP candidate list. If the number of valid MVP candidates is greater than 3, the coder will truncate the TMVP from the list.

There may be problems with this existing AMVP design of the current 3D-HEVC. For example, when a coder operates according to this existing AMVP design of the current 3D-HEVC, identical MVP candidates may be present in the final candidate MVP list, even when there is an available MVP candidate, which is not included in the list, and is different from any candidate in the final candidate MVP list. More particularly, when the two spatial MVP candidates and the IVMP candidate are all available, and the spatial MVP candidates are different from each other, but the first spatial MVP candidate is the same as the IVMP candidate, the coder will not include the TMVP candidate in the candidate MVP list, regardless of its availability or value. In such examples, the TMVP candidate may be a valid, or even preferred option, but will not be available for coding the current block.

The techniques for managing or constructing a candidate MVP list described herein, which may be employed by a coder, such as video encoder 20 or video decoder 30, may overcome these problems with the existing AMVP design of the current 3D-HEVC. For example, the techniques for constructing a candidate MVP list described herein may reduce the likelihood that redundant candidate MVPs will be present in the candidate MVP list. Furthermore, the techniques for constructing a candidate MVP list described herein may increase the likelihood that a non-redundant and available TMVP candidate will be included in the candidate MVP list.

In some examples according to this disclosure, a coder may, prior to pruning the candidate MVP list, include at least three MVPs in the candidate MVP list. The at least three MVPs may include two spatial MVPs and an IVMP. When there are one or more redundant MVPs, e.g., MVPs having the same X and Y amplitudes and pointing to the same reference picture, among the at least three MVPs in the candidate list, the coder may prune the redundant MVPs from the candidate list. If the number of candidate MVPs in the candidate MVP list is less than N, e.g., 3, the coder may add the TMVP to the candidate MVP list. In other examples, the coder includes the two spatial MVP candidates, the IVMP candidate, and the TMVP candidate, prior to pruning redundant ones of the MVPs from the candidate MVP list.

In other examples according to the techniques described herein, the coder may include, in a first list MVPs for a current block, a first spatial MVP and a second spatial MVP. If the second spatial MVP is redundant over the first spatial MVP, the coder prunes one of the first and second spatial MVPs, e.g., the second, from the first list. The coder also includes, in a second list of MVPs for the current block, an IVMP and a TMVP. If the TMVP is redundant over the IVMP, the coder prunes one of the IVMP and TMVP, e.g., the TMVP, from the second list of MVPs. The coder then combines the MVPs remaining in the first and second lists to form a candidate list of MVPs for the current block.

In some of the examples above, the predetermined length, N, of the candidate list may be 3, although the above examples are not limited to N being equal to 3. In one example according to the techniques described herein in which N equals 2, the coder may include, in a candidate list of MVPs for a current block, a first spatial MVP and a second spatial MVP. If the second spatial MVP is redundant over the first spatial MVP, the coder may remove one of the first and second spatial MVPs from the candidate list, and add an IVMP to the candidate list of MVPs

The techniques for constructing a candidate list of MVPs according to this disclosure may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission for applications such as video streaming, video playback, video broadcasting, and/or video telephony.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

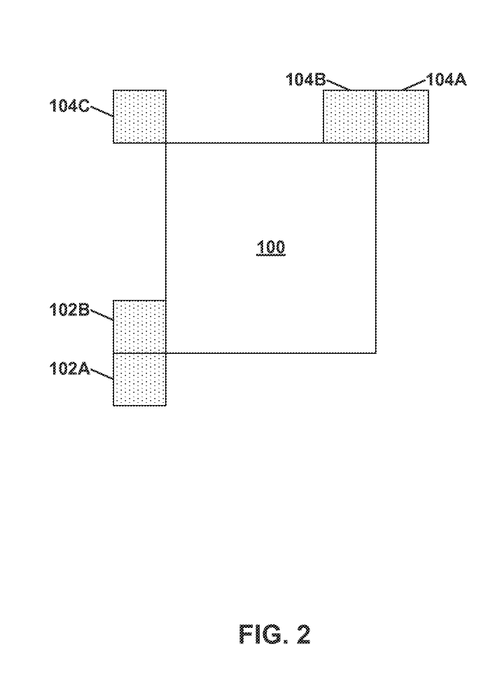

FIG. 2 is a conceptual diagram illustrating an example current video block 100, in relation to a plurality of spatially-neighboring, e.g., adjacent, blocks 102A-B and 104A-C from which spatial candidate MVPs for the current block may be derived. Spatially-neighboring blocks 102A-B are left of current block 100, and spatially-neighboring blocks 104A-C are above current block 100. In some examples, video block 100 and video blocks 102A-B and 104A-C may be PUs, as generally defined in the HEVC standard currently under development.

The spatial relationship of each of spatially-neighboring blocks 102A-B and 104A-C to current block 100 may be described as follows. A luma location (xP, yP) is used to specify the top-left luma sample of the current block relative to the top-left sample of the current picture. Variables nPSW and nPSH denote the width and the height of the current block for luma. The top-left luma sample of spatially-neighboring block 102A is xP−1, yP+nPSH. The top-left luma sample of spatially-neighboring block 102B is xP−1, yP+nPSH−1. The top-left luma sample of spatially-neighboring block 104A is xP+nPSW, yP−1. The top-left luma sample of spatially-neighboring block 104B is xP+nPSW−1, yP−1. The top-left luma sample of spatially-neighboring block 104C is xP−1, yP−1. Although described with respect to luma locations, the current and reference blocks may include chroma components.

Each of spatially-neighboring blocks 102A-B and 104A-C may provide a candidate spatial MVP, e.g., a spatial candidate motion vector, for block 100. Typically, a coder selects one of spatially-neighboring blocks 102A-B to the left of current block 100 to provide a first spatial MVP, referred to “mvA” for block 100. The coder then selects one of spatially-neighboring blocks 104A-C above current block 100 to provide a second spatial MVP, referred to “mvB” for block 100.

A video coder may select mvA from one of spatially-neighboring blocks 102A-B and mvB from one of spatially-neighboring blocks 104A-C according to the following technique. In particular, motion information for a given spatially-neighboring block is used to derive the AMVP candidate of the current PU with its decoded reference index equal to ref_idx_{—}1x (with X being equal to 0 or 1, corresponding to RefPicList0 or RefPicList1) as follows, assuming that the current one of the spatially-neighboring blocks is associated with reference indices and motion vectors as RefIdxLX, mvLX and RefIdxLY, mvLY.
1. If RefIdxLX is available (>=0) and RefIdxLX equal to ref_idx_{—}1X, the AMVP candidate is set to mvLX;
2. Otherwise, if RefIdxLY is available and RefPicListY[RefIdxLY] has the same POC value as RefPicListX[ref_idx_{—}1x], the motion vector candidate is set to mvLY.
3. If RefIdxLX is available, and RefPicListX[RefIdxLX] and RefPicListX[ref_idx_{—}1x] are both short-term or long-term pictures, the AMVP candidate is set to mvLX, in addition, if both of RefPicListX[RefIdxLX] and RefPicListX[ref_idx_{—}1X] are short-term, mvLX is further scaled based on POC distance.
4. Otherwise, if RefIdxLY is available, and RefPicListY[RefIdxLY] and RefPicListX[ref_idx_{—}1X] are both short-term or long-term pictures, the motion vector candidate is set to mvLY, in addition, if both of RefPicListY [RefIdxLY] and RefPicListX[ref_idx_{—}1x] are short-term, mvLY is further scaled based on POC distance.
5. Otherwise, the motion vector candidate is not derived from the current spatially-neighboring block position.

The above steps 1-2 are firstly performed for each spatially-neighboring block located at the left side of the current block, e.g., 102A and 102B, in order. If a candidate is not found, steps 3-5 are performed for each spatially-neighboring block located at the left side of the current block in order until a candidate is found. The derived candidate may be denoted by mvLXA. Meanwhile, the above steps 1-2 are firstly performed for each spatially-neighboring block located at the upper side of the current block, e.g., 104A, 104B and 104C, in order. If a candidate is not found, steps 3-5 are performed for each spatially-neighboring block located at the upper side of the current block in the same order until a candidate is found. The derived candidate may be denoted by mvLXB.

To select mvA and mvB from among spatially-neighboring blocks 102A-B and 104A-C, the coder may determine which of spatially-neighboring blocks 102A-B and 104A-C are available and should be used to derive the candidate. Again, the coder may be a video encoder, such as video encoder 20, or video decoder, such as video decoder 30. Both a video encoder and video decoder may construct a candidate list of MVPs in the same predetermined manner, so that, for example, an encoder may need only signal an index into the candidate list to signal a selected MVP. Some of blocks 102A-B and 104A-C may be unavailable to provide a candidate MVP if, for example, the blocks were intra-coded, or if current block 100 is located proximate a picture or slice boundary. If both spatial MVP candidates, i.e., mvA and mvB, are available, the coder may select one of the candidates as described above.

In the illustrated example, spatially-neighboring blocks 102A-B and 104A-C are to the left of, and above, block 100, respectively. This arrangement is typical, as most coders code video blocks in raster scan order from the top-left of a picture. Accordingly, in such examples, spatially-neighboring blocks 102A-B and 104A-C will typically be coded prior to current block 100. However, in other examples, e.g., when a coder codes video blocks in a different order, spatially-neighboring blocks 102A-B and 104A-C may be located to the right of, or below, current block 100.

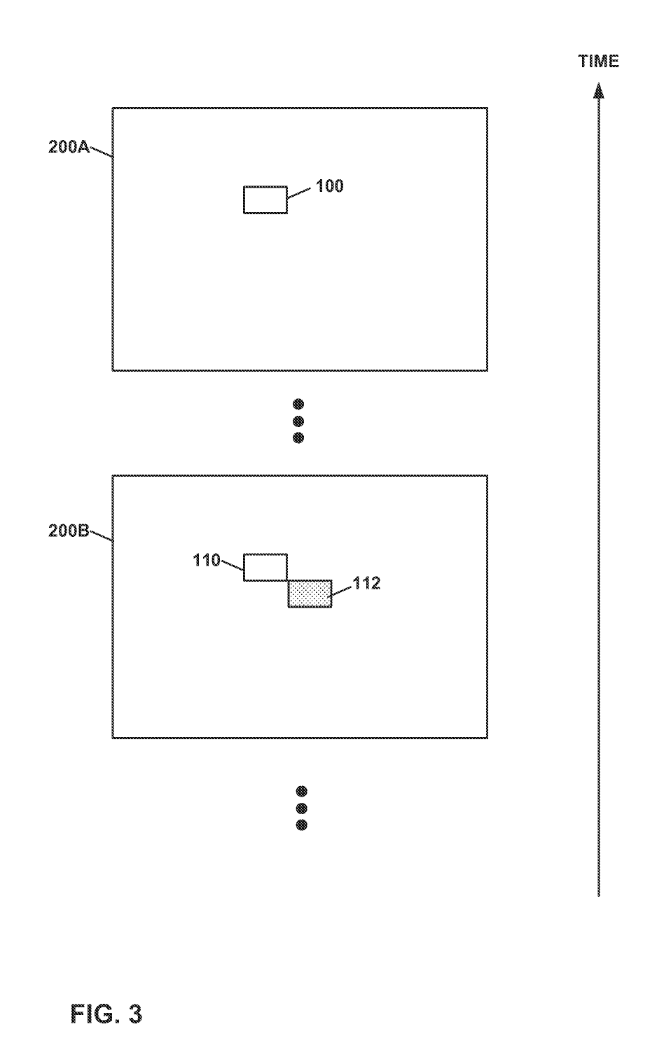

FIG. 3 is a conceptual diagram illustrating an example picture 200A including a current video block 100, and a temporal reference picture 200B, within a video sequence. Temporal reference picture 200B is a picture coded prior to picture 200A. Temporal reference picture 200B is not necessarily the immediately prior picture, in time, to picture 200A. A coder may select temporal reference picture 200B from among a plurality of possible temporal reference pictures, and a reference picture index value may indicate which of the temporal reference pictures to select.

Temporal reference picture 200B includes a co-located block 110, which is co-located in picture 200B relative to the location of current block 100 in picture 200A. Temporal reference picture 200B also includes a temporal reference block 112 for current block 100 in picture 200A. A coder may derive a TMVP for current block 100 based on prediction parameters of reference block 112. Temporal reference block 112 is a spatially-neighboring block to co-located block 110. In the illustrated example, reference block 112 is located to the right of and below co-located block 110. In some examples, reference block may be a right-bottom PU of the co-located PU, e.g., co-located block 110.

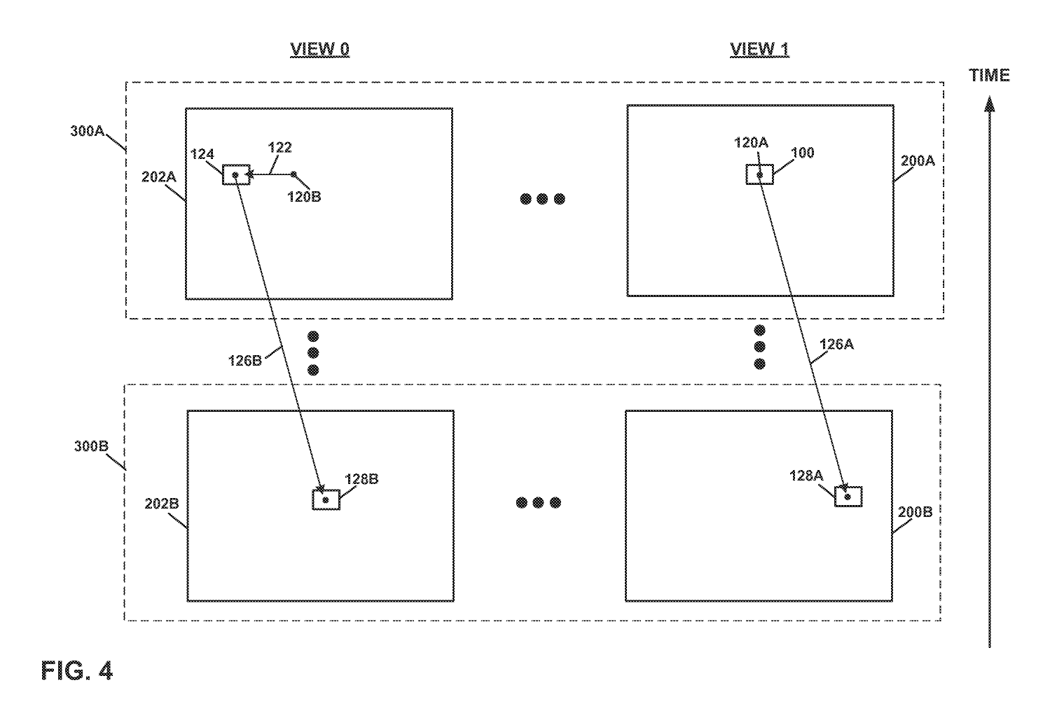

FIG. 4 is a conceptual diagram illustrating pictures of a plurality of access units, each access unit including a plurality of views. In particular, FIG. 4 illustrates access units 300A and 300B, each of which may represent a different point in time in a video sequence. Although two access units 300A and 300B are illustrated, the video data may include many additional access units, both forward and backward in the sequence relative to access unit 300A, and access units 300A and 300B need not be adjacent or consecutive access units.

The video data including access units 300A and 300B is MVC video data, i.e., includes multiple views of a common scene, and may, in some examples, be MVC plus depth data, where each view includes a texture component and a depth component. FIG. 4 illustrates pictures of two views, VIEW 0 and VIEW 1. The video data may include additional views not shown in FIG. 4.

Access unit 300A includes picture 200A of VIEW 1. Picture 200A includes current block 100. Access unit 300A may be referred to as the current access unit, VIEW 1 may be referred to as the current view, and picture 200A may be referred to as the current picture. Access unit 300A also includes picture 202A of VIEW 0. VIEW 0 may be referred to as a reference view, and picture 202A may be referred to as an inter-view reference picture. Access unit 300B includes picture 200B of VIEW 1, and picture 202B of VIEW 0. Picture 200B of VIEW 1 may be referred to as a temporal reference picture for picture 200A.

One of the most efficient coding tools in 3D-HEVC is inter-view motion prediction (IVMP) where the motion parameters of a block in a dependent view are predicted or inferred based on already coded motion parameters in another view, i.e., a reference view, of the same access unit. In addition, the IVMP candidate may be the motion parameters converted from a disparity vector which may be used as a candidate for AMVP/merge modes. To include the inter-view motion prediction, the AMVP mode, as well as the merge mode, for 3D-HEVC has been extended in a way that an IVMP (inter-view motion vector predictor) candidate is added to the candidate list of MVPs for a block to be coded.

To derive an IVMP for current block 100, a coder identifies a sample 120A in block 100, and a co-located sample 120B in inter-view reference picture 202A. Based on disparity information for picture 200A relative to interview reference picture 202A, the coder determines a disparity vector 122. The disparity information could be derived from a depth map or other depth information for picture 200A. Based on disparity vector 122, the coder identifies a reference block 124 in inter-view reference picture 202A of the reference view (VIEW 0).

If the reference picture index for current block 100 in RefPicListX (wherein X could be 0 or 1) refers to inter-view reference picture 202A, the coder sets the IVMP candidate for current block 100 equal to disparity vector 122, which then becomes a so-called disparity motion vector for block 100. In particular, the disparity motion vector points to the block 124 in picture 202A as a reference block for prediction of block 100A in picture 200A. In one example, the vertical component of the disparity motion vector may be forced to be 0. If the current reference picture index for current block 100 in RefPicListX (wherein X could be 0 or 1) refers to temporal reference picture 200B in access unit 300B, the coder determines whether reference block 124 was coded based on a motion vector that referred to the same access unit 300B as the current reference index. In the example illustrated by FIG. 4, reference block 124 was coded based on a motion vector 126B either in RefPicListX or RefPicListY (where Y is equal to 1-X) that points to a block 128B in picture 202B in access unit 300B. In such cases, the coder sets the IVMP candidate for current block 100 equal to a motion vector 126A that points to a temporal reference block 128A in temporal reference picture 200B of VIEW 1. Motion vector 126A corresponds to motion vector 126B, e.g., the horizontal and vertical components of the motion vectors are the same, but motion vectors 126A and 126B refer to different pictures associated with different views in the same access unit. In some examples, if the motion vector of reference block 124 points to a different access unit then the reference picture index for current block 100, the coder may consider IVMP candidate unavailable for current block 100. Accordingly, when the reference block has a reference picture either in List 0 or List 1 in the same access unit as the reference picture of the current block with the current reference index in the current reference picture list, the corresponding motion information is treated as available.

A variety of techniques may be used to derive disparity vectors, such as disparity vector 122. In some examples, video for one or more views is coded dependent of depth data, and the video coder uses the coded depth map(s) to derive disparity vectors. In other examples, where video is coded independently of depth data, a video coder may derive disparity vectors based on coded motion vectors and disparity motion vectors. This approach can also be used for video only, but such an approach increases the complexity greatly, especially at the decoder side.

In U.S. provisional application No. 61/682,221, filed Aug. 11, 2012, a disparity vector construction method from Spatial Disparity Vectors (SDV), Temporal Disparity Vectors (TDV) or Implicit Disparity Vectors (IDV) is proposed for inter-view motion prediction. The entire content of this application is incorporated herein by reference.

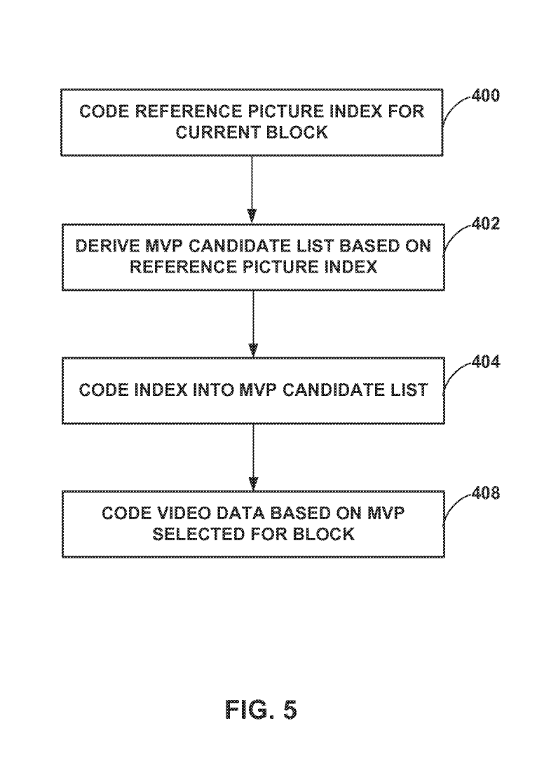

FIG. 5 is a flowchart illustrating an example technique for deriving an MVP candidate list for a current block 100 and coding video data based on an MVP selected from the candidate list, in accordance with an example of this disclosure. According to the example method of FIG. 5, a coder, e.g., video encoder 20 or video decoder 30, codes a reference picture index for the current block 100 (400). The reference picture index identifies a reference picture for the current block. The reference picture may be a temporal reference picture 200B, or an inter-view reference picture 202A.

The coder derives an MVP candidate list for current block 100, in the defined manner, based on the reference picture index (402). For example, the coder may select candidate MVPs based on the reference picture index by selecting candidate spatial MVPs (mvA or mvB) or a TMVP, as described above with respect to FIGS. 2 and 3. As another example, the coder may additionally select a candidate IVMP to be either a disparity motion vector or a temporal motion vector based on whether the reference picture index refers to an interview reference picture or a temporal reference picture, as described above with respect to FIG. 4.

The coder codes an index into the MVP candidate list (404). The MVP candidate list index, which may be denoted “mvp_idx,” indicates which of the candidate MVPs has been selected to code the current block 100. The coder then codes the video data associated with the block, e.g. the video data associated with the PU, based on the MVP selected for the video block (408).

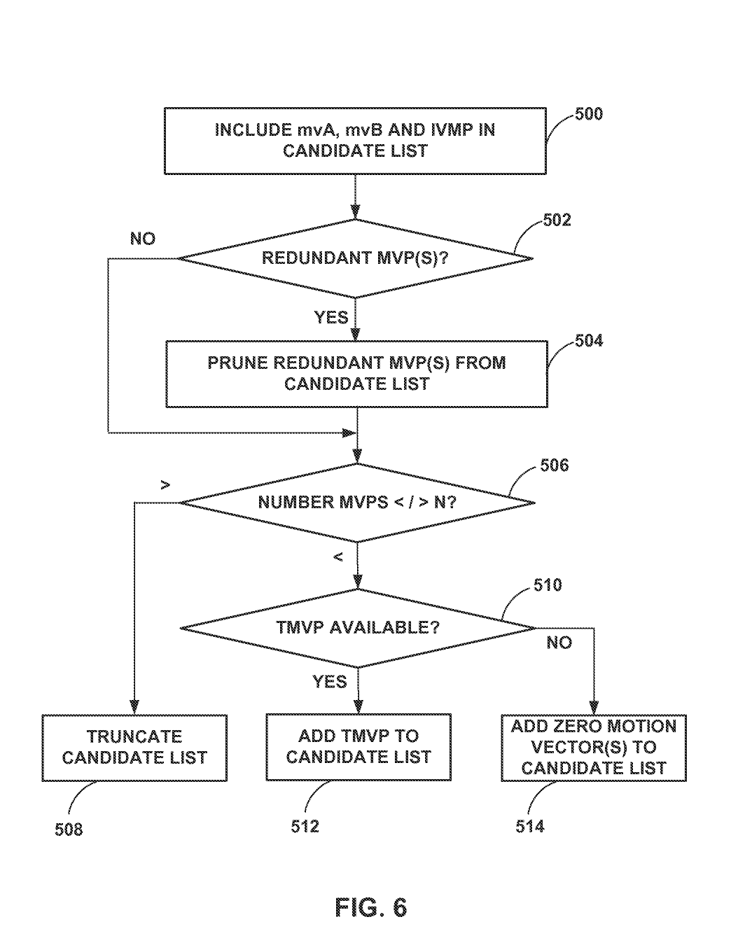

FIGS. 6-9 are flowcharts illustrating example techniques for constructing an MVP candidate list for a current block of video data 100. The example techniques of FIGS. 6-9 may be implemented by a video coder, e.g., video encoder 20 or video decoder 30.

According to the example of FIG. 6, the coder includes, if available, first and second spatial MVP candidates, e.g., mvA and mvB, as well as an IVMP candidate, in an MVP candidate list (500). In some examples, the coder may include, in order, the mvA, mvB and IVMP in the candidate list. The coder then determines whether any of the three MVP candidates are redundant, e.g., have identical motion vector values and refer to the same reference picture (502). If there are redundant MVPs, the coder then prunes, e.g., removes, one or more redundant MVPs from the candidate list (504).

In some examples, when there are redundant MVPs, the coder selects which of the MVPs to prune based on the positions of the MVPs in the candidate list. Typically, the coder may prune the MVP have the greater magnitude candidate list index value. For example, where mvA, mvB and IVMP are included, in order, in the candidate list, the coder may prune mvB when redundant over mvA, and IVMP when redundant over mvA or mvB. Pruning the MVP having the greater magnitude index value may increase coding efficiency, because signaling higher magnitude index values may require more bits in the bitstream.

Whether there are redundant MVPs that are pruned (YES of 502 and 504), or not (NO of 502), the coder determines whether the number of MVPs in the candidate list exceeds or is less than the predetermined length, N, for the candidate list (506). N may be, for example, 1, 2, or 3. If there are more than N MVPs in the candidate list, the coder truncates the candidate list to N MVPs (508).

If there are less than N MVPs in the candidate list, the coder determines whether a TMVP is available (510). If a TMVP is available, the coder adds the TMVP to the candidate list (512). Although TMVP may be redundant, further pruning of the candidate list is not necessarily performed. If a TMVP is not available, the coder adds one or more zero value MVPs to the candidate list so that the MVP candidate list includes N MVPs (514). The coder may also add zero value MVPs to the candidate list after TMVP is added, if the candidate list still includes less than N candidates.

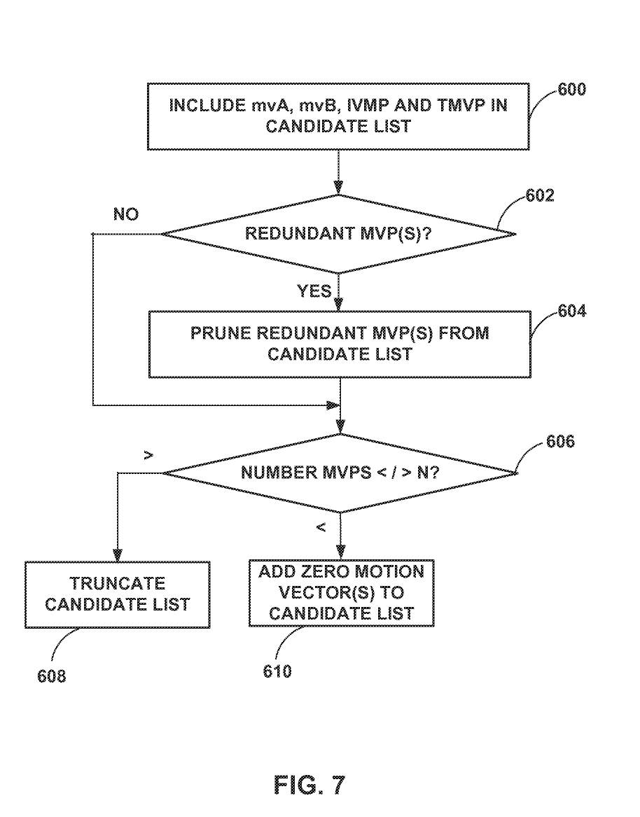

FIG. 7 is a flowchart illustrating another example technique for constructing a MVP candidate list for a current block of video data 100. The example technique of FIG. 7 may be implemented by a video coder, e.g., video encoder 20 or video decoder 30.

According to the example of FIG. 7, prior to pruning, the coder includes, if available, first and second spatial MVP candidates, e.g., mvA and mvB, as well as an IVMP candidate and a TMVP candidate, in an MVP candidate list (600). In some examples, the coder may include, in order, the mvA, mvB, IVMP and TMVP candidates in the candidate list. The coder then determines whether any of the four MVP candidates are redundant (602). If there are redundant MVPs, the coder then prunes, e.g., removes, one or more redundant MVPs from the candidate list (604).

Whether there are redundant MVPs that are pruned (YES of 602 and 604), or not (NO of 602), the coder determines whether the number of MVPs in the candidate list exceeds or is less than the predetermined length, N, for the candidate list (506). N may be, for example, 1, 2, or 3. If there are more than N MVPs in the candidate list, the coder truncates the candidate list to N MVPs (608). If there are less than N MVPs in the candidate list, the coder adds one or more zero value MVPs to the candidate list so that the MVP candidate list includes N MVPs (610).

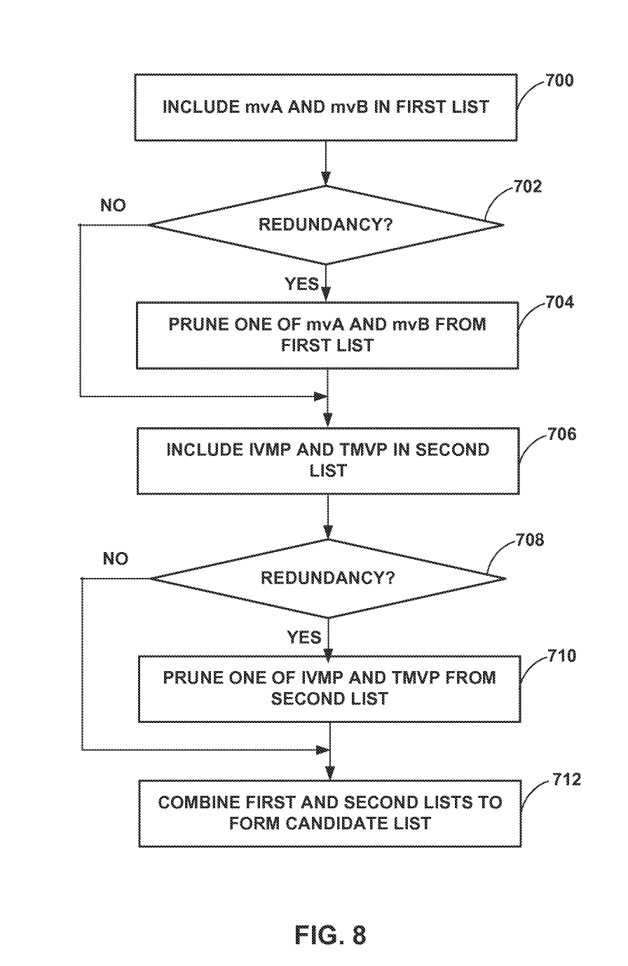

FIG. 8 is a flowchart illustrating another example technique for constructing a MVP candidate list for a current block of video data 100. The example technique of FIG. 8 may be implemented by a video coder, e.g., video encoder 20 or video decoder 30.

According to the example of FIG. 8, the coder includes, if available, mvA and mvB in a first list (700). The coder may include mvA and mvB, in order, in the first list. The coder then determines whether there is redundancy between mvA and mvB (702). If there is redundancy, the coder prunes one of mvA and mvB, e.g., mvB, from the first list (704).

Whether there are redundant MVPs that are pruned from the first list (YES of 702 and 704), or not (NO of 702), the coder includes an IVMP and a TMVP, e.g., in order, in a second list (706). The coder then determines whether there is redundancy between the IVMP and TMVP (708). If there is redundancy, the coder prunes one of the IVMP and TMVP, e.g., TMVP, from the first list (710).

Whether there are redundant MVPs that are pruned from the second list (YES of 708 and 710), or not (NO of 708), the coder combines the MVPs remaining in the first and second lists to form a candidate MVP list (714). When combined into the candidate list, the entries in the first list may precede the entries in the second list, or the entries in the second list may precede the entries in the first list. Additionally, although not illustrated in FIG. 8, if the candidate list includes greater or less than N MVPs, the coder may truncate the candidate list or add zero value MVPs to the list. N may be, for example, 1, 2, or 3.

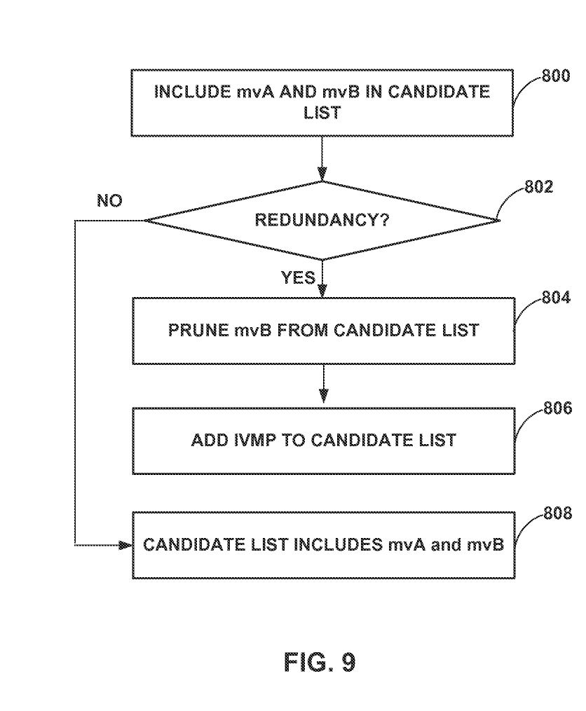

FIG. 9 is a flowchart illustrating another example technique for constructing a MVP candidate list for a current block of video data 100. The example technique of FIG. 9 may be implemented by a video coder, e.g., video encoder 20 or video decoder 30.

According to the example of FIG. 9, the coder includes, if available, an mvA and mvB, e.g., in order, in the candidate list (800). If an mvA and mvB are both available, the coder then determines whether there is redundancy between the mvA and mvB (802). If there is redundancy, the coder prunes the mvB from the candidate list (804). Additionally, if the mvB is removed from the candidate list, the coder may add IVMP to the candidate list (806). If there is not redundancy (NO of 802), the MVP candidate list includes mvA and mvB (808).

In the example of FIG. 9, the predetermined length, N, of the MVP candidate list may be 2. Although not illustrated in FIG. 9, the candidate list may include fewer than 2 MVPs, e.g., if an mvA or mvB were not available, or if the mvB were pruned and IVMP were not available. In such cases, the coder may add a zero value MVP to the candidate list.

The techniques for motion vector prediction for 3D video coding described herein may be performed by a coder, such as video encoder 20 or video decoder 30. Both an encoder and a decoder may construct a candidate MVP list in substantially the same predetermined manner, e.g., according to the techniques described herein. An encoder may select one of the candidate MVPs from the list, and use the motion prediction parameters of the selected MVP to encode the video data associated with the current block, e.g., the current PU in the context of 3D-HEVC. The encoder may signal an index into the candidate MVP list in a bitstream that includes the coded video data. A decoder may decode this candidate list index to determine the candidate MVP selected by the encoder, and may decode the video data associated with the current block using the motion parameters of the selected MVP.

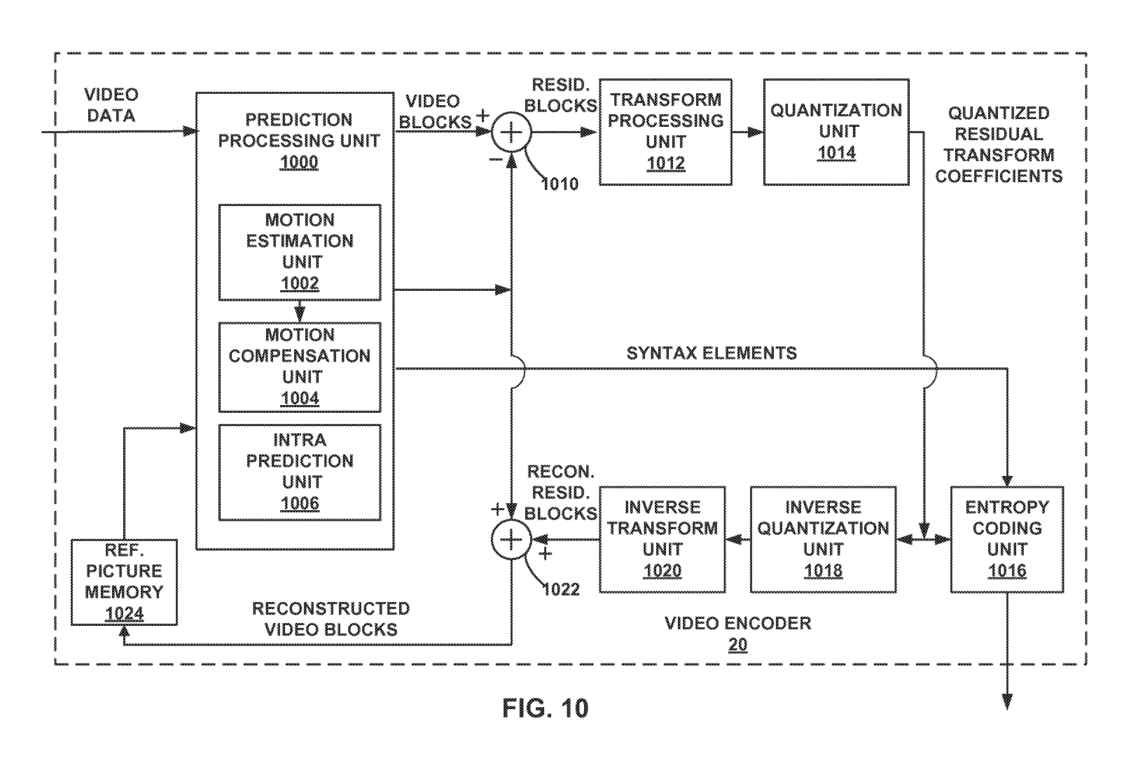

FIG. 10 is a block diagram illustrating an example of a video encoder 20 that may implement the techniques described in this disclosure for managing a candidate list of MVPs. Video encoder 20 may be configured to perform any or all of the techniques of this disclosure, e.g., perform any of the example techniques illustrated in FIGS. 6-9.

Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 10, video encoder 20 receives video data. In the example of FIG. 10, video encoder 20 a prediction processing unit 1000, a summer 1010, a transform processing unit 1012, a quantization unit 1014, an entropy encoding unit 1016, and a reference picture memory 1024. Prediction processing unit 1000 includes a motion estimation unit 1002, motion compensation unit 1004, and an intra-prediction unit 1006.

For video block reconstruction, video encoder 20 also includes inverse quantization unit 1018, inverse transform unit 1020, and a summer 1022. A deblocking filter (not shown in FIG. 10) may also be included to filter block boundaries to remove blockiness artifacts from reconstructed video. If desired, the deblocking filter would typically filter the output of summer 1022. Additional filters (in loop or post loop) may also be used in addition to the deblocking filter. Such filters are not shown for brevity, but if desired, may filter the output of summer 1010 (as an in-loop filter).

During the encoding process, video encoder 20 receives a video picture or slice to be coded. Prediction processing unit 1000 divides the picture or slice into multiple video blocks. Motion estimation unit 1002 and motion compensation unit 1004 perform inter-predictive coding of the received video block relative to one or more blocks in one or more reference pictures stored in reference picture memory 1024 to provide temporal or inter-view prediction. Intra-prediction unit 1006 may alternatively perform intra-predictive coding of the received video block relative to one or more neighboring blocks in the same picture or slice as the block to be coded to provide spatial prediction. Video encoder 20 may perform multiple coding passes, e.g., to select an appropriate coding mode for each block of video data.

Moreover, prediction processing unit 1000 may partition blocks of video data into sub-blocks, based on evaluation of previous partitioning schemes in previous coding passes. For example, prediction processing unit 1000 may initially partition a picture or slice into LCUs, and partition each of the LCUs into sub-CUs according to different prediction modes based on rate-distortion analysis (e.g., rate-distortion optimization). Prediction processing unit 1000 may produce a quadtree data structure indicative of partitioning of an LCU into sub-CUs. Leaf-node CUs of the quadtree may include one or more PUs and one or more TUs.

Prediction processing unit 1000 may select one of the coding modes (intra-coding or inter-coding) e.g., based on error results, and provide the resulting intra-coded or inter-coded block to summer 1010 to generate residual block data and to summer 1022 to reconstruct the encoded block for use as part of a reference picture stored in reference picture memory 1024. Prediction processing unit 1000 also provides syntax elements, such as motion vectors, intra-mode indicators, partition information, reference picture index values, MVP candidate list index values, and other such syntax information, to entropy encoding unit 1016 for use by video decoder 30 in decoding the video blocks.

Prediction processing unit 1000, e.g., motion estimation unit 1002 and/or motion compensation unit 1004, may perform the techniques described in this disclosure for constructing a candidate list of MVPs. For example, prediction processing unit 1000, e.g., motion estimation unit 1002 and/or motion compensation unit 1004, may perform any of the example techniques of FIG. 6-9. Motion estimation unit 1002 and motion compensation unit 1004 may be highly integrated, but are illustrated separately for conceptual purposes.

Motion estimation, performed by motion estimation unit 1002, is the process of generating motion vectors or disparity motion vectors, which estimate motion for video blocks. A motion vector or disparity motion vector may indicate the displacement of a current PU of a current video block within a current picture relative to a predictive block within a reference picture, e.g., a temporal reference picture or an inter-view reference picture. A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 1024. For example, video encoder 20 may interpolate values of one-quarter pixel positions, one-eighth pixel positions, or other fractional pixel positions of the reference picture. Therefore, motion estimation unit 1002 may perform a motion search relative to the full pixel positions and fractional pixel positions and output a motion vector with fractional pixel precision. Motion estimation unit 1002 may select the reference picture from a reference picture list, e.g., List 0 or List 1, which identifies one or more reference pictures stored in reference picture memory 1024. Motion estimation unit 1002 sends the calculated motion vector or disparity motion vector to entropy encoding unit 1016 and motion compensation unit 1004. In some examples described herein, in which AVMP or merge mode is employed, rather than sending the calculated prediction vector to the entropy encoding unit, motion estimation unit 1002 sends an index into an MVP candidate list and a reference picture index to the entropy encoding unit. A decoder may use the same techniques as encoder 20 to construct the candidate MVP list and may select the MVP based on the index signaled by motion estimation unit 1002.

Motion compensation, performed by motion compensation unit 1004, may involve fetching or generating the predictive block based on the prediction vector determined by motion estimation unit 1002. Again, motion estimation unit 1002 and motion compensation unit 1004 may be functionally integrated, in some examples. Upon receiving the prediction vector for the PU of the current video block, motion compensation unit 1004 may locate the predictive block to which the prediction vector points in one of the reference picture lists. Summer 1010 forms a residual video block by subtracting pixel values of the predictive block from the pixel values of the current video block being coded, forming pixel difference values. In general, motion estimation unit 1002 performs motion estimation relative to luma components, and motion compensation unit 1004 uses prediction vectors calculated based on the luma components for both chroma components and luma components.

Intra-prediction unit 1006 may intra-predict a current block, as an alternative to the inter-prediction performed by motion estimation unit 1002 and motion compensation unit 1004. In particular, intra-prediction unit 1006 may determine an intra-prediction mode to use to encode a current block. In some examples, intra-prediction unit 1006 may encode a current block using various intra-prediction modes, e.g., during separate encoding passes, and intra-prediction unit 1006 may select an appropriate intra-prediction mode to use from the tested modes.

For example, intra-prediction unit 1006 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 1006 may calculate ratios from the distortions and rates for the various encoded blocks to determine which intra-prediction mode exhibits the best rate-distortion value for the block.

After selecting an intra-prediction mode for a block, intra-prediction unit 1006 may provide information indicative of the selected intra-prediction mode for the block to entropy encoding unit 1016. Entropy encoding unit 1016 may encode the information indicating the selected intra-prediction mode for use by video decoder 30 in decoding the video block. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from prediction module 1001 from the original video block being coded. Summer 1010 represents the component or components that perform this subtraction operation. Transform processing unit 1012 applies a transform, such as a discrete cosine transform (DCT) or a conceptually similar transform, to the residual block, producing a video block comprising residual transform coefficient values. Transform processing unit 1012 may perform other transforms which are conceptually similar to DCT. Wavelet transforms, integer transforms, sub-band transforms or other types of transforms could also be used. In any case, transform processing unit 1012 applies the transform to the residual block, producing a block of residual transform coefficients. The transform may convert the residual information from a pixel value domain to a transform domain, such as a frequency domain. Transform processing unit 1012 may send the resulting transform coefficients to quantization unit 1014.

Quantization unit 1014 quantizes the values of the transform coefficients to further reduce bit rate. The quantization process may reduce the bit depth associated with some or all of the coefficients. The degree of quantization may be modified by adjusting a quantization parameter. In some examples, quantization unit 1014 may then perform a scan of the matrix including the quantized transform coefficients. Alternatively, entropy encoding unit 1016 may perform the scan.

Following quantization, entropy encoding unit 1016 entropy encodes the quantized transform coefficients. For example, entropy encoding unit 1016 may perform context adaptive variable length coding (CAVLC), context adaptive binary arithmetic coding (CABAC), syntax-based context-adaptive binary arithmetic coding (SBAC), probability interval partitioning entropy (PIPE) encoding or another entropy encoding technique. In the case of context-based entropy encoding, context may be based on neighboring blocks. Following the entropy encoding by entropy encoding unit 1016, the encoded bitstream may be transmitted to another device (e.g., video decoder 30) or archived for later transmission or retrieval.

Inverse quantization unit 1018 and inverse transform unit 1020 apply inverse quantization and inverse transformation, respectively, to reconstruct the residual block in the pixel domain and then add the residual to the corresponding predictive block to reconstruct the coded block, e.g., for later use as a reference block. Motion compensation unit 1004 may calculate a reference block by adding the residual block to a predictive block of one of the reference pictures of reference picture memory 1024. Motion compensation unit 1004 may also apply one or more interpolation filters to the reconstructed residual block to calculate sub-integer pixel values for use in motion estimation. Summer 1022 adds the reconstructed residual block to the motion compensated prediction block produced by motion compensation unit 1004 to produce a reconstructed video block for storage in reference picture memory 1024. The reconstructed video block may be used by motion estimation unit 1012 and motion compensation unit 1014 as a reference block to inter-code a block in a subsequent picture, e.g., using the motion vector prediction and inter-view coding techniques described herein.

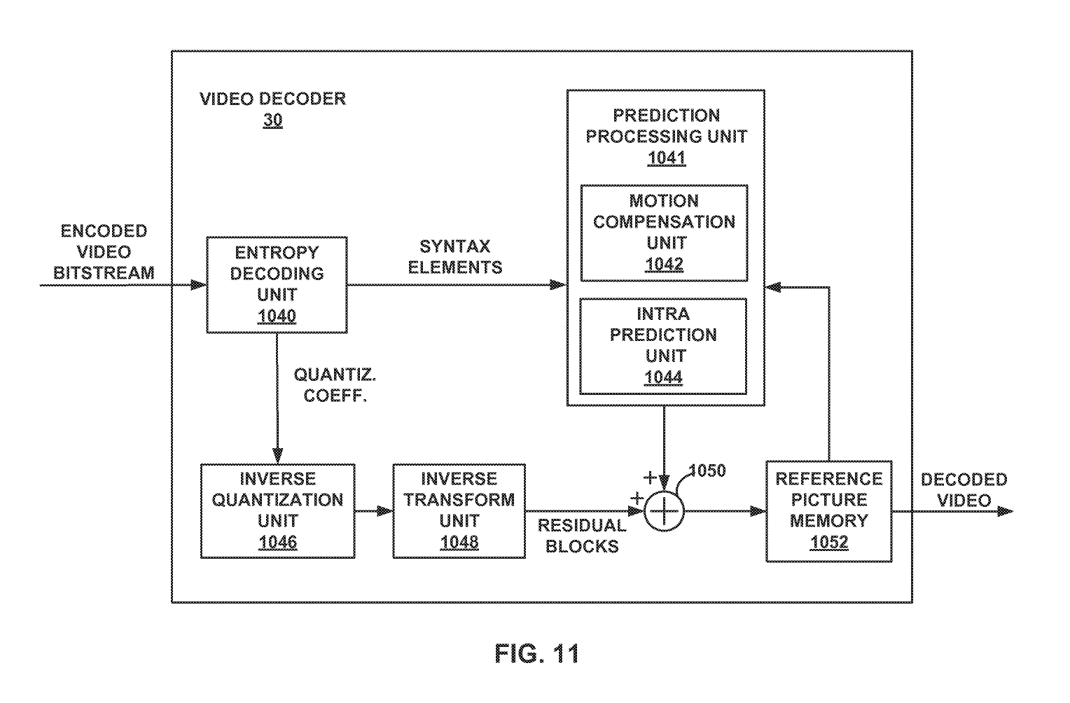

FIG. 11 is a block diagram illustrating an example of a video decoder 30 that may implement the techniques described in this disclosure for managing a candidate list of MVPs. Video decoder 30 may be configured to perform any or all of the techniques of this disclosure, e.g., perform any of the example techniques illustrated in FIGS. 6-9.

In the example of FIG. 11, video decoder 30 includes an entropy decoding unit 1040, prediction processing unit 1041, inverse quantization unit 1046, inverse transformation unit 1048, reference picture memory 1052 and summer 1050. Prediction processing unit 1041 includes a motion compensation unit 1042 and intra prediction unit 1044. Video decoder 30 may, in some examples, perform a decoding pass generally reciprocal to the encoding pass described with respect to video encoder 20 (FIG. 10). Motion compensation unit 1042 may generate prediction data based on prediction vectors or, according to the techniques described herein, based on reference picture and MVP candidate list indices received from entropy decoding unit 1040. Intra-prediction unit 1044 may generate prediction data based on intra-prediction mode indicators received from entropy decoding unit 1040.

During the decoding process, video decoder 30 receives an encoded video bitstream that represents video blocks of an encoded video slice and associated syntax elements from video encoder 20. Entropy decoding unit 1040 of video decoder 30 entropy decodes the bitstream to generate quantized coefficients, prediction vectors, reference picture and MVP candidate list indices, intra-prediction mode indicators, and other syntax elements, which are forwarded to prediction processing unit 1041. Video decoder 30 may receive the syntax elements at the video slice level and/or the video block level.

When the video slice is coded as an intra-coded (I) slice, intra prediction unit 1044 may generate prediction data for a video block of the current video slice based on a signaled intra prediction mode and data from previously decoded blocks of the current picture. When the video slice is coded as an inter-coded (i.e., B, P or GPB) slice, motion compensation unit 1042 produces reference blocks for a video block of the current video slice based on the prediction vectors, or reference picture and MVP candidate list indices, and other syntax elements received from entropy decoding unit 1040. The reference blocks may be produced from one of the temporal or inter-view reference pictures within reference picture memory 1052. The reference pictures may be listed in one of the reference picture lists, e.g., List 0 and List 1, constructed by video decoder 30 using default construction techniques.

Prediction processing unit 1041, e.g., motion compensation unit 72, may perform any of the motion vector prediction for 3D video coding techniques, e.g., any of the techniques for constructing a candidate MVP list, described herein. For example, prediction module 1041, e.g., motion compensation unit 1042, may perform any of the example techniques illustrated by FIGS. 6-9. Accordingly, prediction processing unit 1041 may receive information from the encoder in the bitstream, such as a reference picture index and MVP candidate list index. Prediction processing unit 1041 may construct a candidate list of MVPs using the same techniques used by the encoder, e.g., the techniques described with respect to FIGS. 7-9, and select one of the MVPs from the list for motion prediction of a current block based on the candidate MVP list index received from the encoder.

Motion compensation unit 1042 may also perform interpolation based on interpolation filters. Motion compensation unit 1042 may use interpolation filters as used by video encoder 20 during encoding of the video blocks to calculate interpolated values for sub-integer pixels of reference blocks. In this case, motion compensation unit 1042 may determine the interpolation filters used by video encoder 20 from the received syntax elements and use the interpolation filters to produce predictive blocks.

Inverse quantization unit 1046 inverse quantizes, i.e., de-quantizes, the quantized transform coefficients provided in the bitstream and decoded by entropy decoding unit 1040. The inverse quantization process may include use of a quantization parameter QP_{Y} calculated by video decoder 30 for each video block in the video slice to determine a degree of quantization and, likewise, a degree of inverse quantization that should be applied. Inverse transform unit 1048 applies an inverse transform, e.g., an inverse DCT, an inverse integer transform, or a conceptually similar inverse transform process, to the transform coefficients in order to produce residual blocks in the pixel domain.

After motion compensation unit 1042 generates the predictive block for the current video block, video decoder 30 forms a decoded video block by summing the residual blocks from inverse transform unit 1048 with the corresponding predictive blocks generated by motion compensation unit 1042. Summer 1050 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given picture are then stored in reference picture memory 1052, which stores reference pictures used for subsequent motion compensation. Reference picture memory 1052 may also store the decoded video for later presentation on a display device, such as display device 32 of FIG. 1.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
including at least three motion vector predictors (MVPs) in a candidate list of MVPs for a current block in a first view of a current access unit of the video data, wherein the at least three MVPs comprise an inter-view motion vector predictor (IVMP), wherein the IVMP is one of derived from a block in a second view of the current access unit or converted from a disparity vector for the current block in the first view of the current access unit;
when there are one or more redundant MVPs among the at least three MVPs in the candidate list, pruning at least one of the redundant MVPs from the candidate list;
coding an index into the candidate list of MVPs, the index referencing one of the MVPs from the candidate list for the current block; and
coding the video data based on the one of the MVPs from the candidate list selected for the current block.

2. The method of claim 1, wherein the at least three MVPs further comprise a first spatial MVP derived from a first spatially-neighboring block to the current block in the first view of the current access unit, and a second spatial MVP derived from a second spatially-neighboring block to the current block in the first view of the current access unit.

3. The method of claim 2, wherein the first spatially-neighboring block comprises a neighboring block on a left side of the current block, and the second spatially-neighboring block comprises a neighboring block on an upper side of the current block.

4. The method of claim 2,
wherein including the at least three MVPs in the candidate list comprises including, in order, the first spatial MVP, the second spatial MVP, and the IVMP,
wherein magnitudes of indices into the candidate list increase according to the order, and
wherein pruning redundant ones of the at least three MVPs from the candidate list comprises removing one of the MVPs with a greater index magnitude than another of the MVPs.

5. The method of claim 1, further comprising:
after pruning redundant ones of the MVPs from the candidate list, determining whether a number of MVPs in the candidate list is less than a predetermined length (N) of the candidate list; and
when the number of MVPs in the candidate list is less than N, adding a temporal motion vector predictor (TMVP) derived from a block in the first view in a previously-coded access unit of the video data to the candidate list.

6. The method of claim 5, wherein the block in the first view in the previously-coded access unit comprises one of a spatially-neighboring block to a block or a spatially-neighboring block of the center block of a block in the first view in the previously coded access unit that is co-located relative to a location of the current block in the first view of the current access unit.

7. The method of claim 5, wherein N equals one of 1, 2, or 3.

8. The method of claim 1, wherein the at least three MVPs further comprise a temporal motion vector predictor (TMVP) derived from a block in the first view in a previously-coded access unit of the video data.

9. The method of claim 8, wherein the at least three MVPs further comprise a first spatial MVP derived from a first spatially-neighboring block to the current block in the first view of the current access unit, and a second spatial MVP derived from a second spatially-neighboring block to the current block in the first view of the current access unit.

10. The method of claim 1, further comprising:
after pruning, determining whether a number of MVPs in the candidate list is less than a length of the candidate list (N); and
when the number of MVPs in the candidate list is less than N, including one or more zero motion vector candidates as the end of the candidate list.

11. The method of claim 1, further comprising:
after pruning, determining whether a number of MVPs in the candidate list is greater than a length of the candidate list (N); and
when the number of MVPs in the candidate list is greater than N, removing one or more of the MVPs from the candidate list until the number of candidates is equal to N.

12. The method of claim 1, further comprising identifying the block in the second view of the current access unit based on the disparity vector for the current block in the first view of the current access unit.

13. The method of claim 12, further comprising, when a reference picture index for the current block refers to the second view, setting the IVMP equal to the disparity vector.

14. The method of claim 12, further comprising, when a reference picture index for the current block refers to a first temporal reference picture from a previously-coded access unit, and a motion vector for the block in the second view of the current access unit points to a second temporal reference picture from the same previously-coded access unit, setting the IVMP for the current block to be a motion vector that points from the current block to a block in the first temporal reference picture and corresponds to the motion vector from the block in the second view of the current access unit to the second temporal reference picture.

15. The method of claim 1, wherein pruning redundant ones of the at least three MVPs from the candidate list comprise removing one of the MVPs from the candidate list that is identical to another of the MVPs in the candidate list.

16. The method of claim 1, wherein coding the index comprises decoding the index with a video decoder, and coding the video data comprises decoding the video data with the video decoder.

17. The method of claim 16, wherein including the at least three MVPs in the candidate list and pruning the at least one of the redundant MVPs comprises including the at least three MVPs in the candidate list and pruning the at least one of the redundant MVPs based on information received in a bitstream including the video data from a video encoder.

18. The method of claim 1, wherein coding the index comprises encoding the index with a video encoder, and coding the video data comprises encoding the video data with the video encoder.

19. A device comprising a video coder configured to:
include at least three motion vector predictors (MVPs) in a candidate list of MVPs for a current block in a first view of a current access unit of the video data, wherein the at least three MVPs comprise an inter-view motion vector predictor (IVMP), and wherein the IVMP is one of derived from a block in a second view of the current access unit or converted from a disparity vector for the current block in the first view of the current access unit;
when there are one or more redundant MVPs among the at least three MVPs in the candidate list, prune at least one of the redundant MVPs from the candidate list;
code an index into the candidate list of MVPs, the index referencing one of the MVPs from the candidate list for the current block; and
code the video data based on the one of the MVPs from the candidate list selected for the current block.

20. The device of claim 19, wherein the at least three MVPs further comprise a first spatial MVP derived from a first spatially-neighboring block to the current block in the first view of the current access unit, and a second spatial MVP derived from a second spatially-neighboring block to the current block in the first view of the current access unit.

21. The device of claim 20, wherein the first spatially-neighboring block comprises a neighboring block on a left side of the current block, and the second spatially-neighboring block comprises a neighboring block on an upper side of the current block.

22. The device of claim 20,
wherein the video coder is configured to include, in order, the first spatial MVP, the second spatial MVP, and the IVMP in the candidate list,
wherein magnitudes of indices into the candidate list increase according to the order, and
wherein the video coder is configured to prune redundant ones of the at least three MVPs from the candidate list by at least removing one of the MVPs with a greater index magnitude than another of the MVPs.

23. The device of claim 19, wherein the video coder is further configured to:
after pruning redundant ones of the MVPs from the candidate list, determine whether a number of MVPs in the candidate list is less than a predetermined length (N) of the candidate list; and
when the number of MVPs in the candidate list is less than N, add a temporal motion vector predictor (TMVP) derived from a block in the first view in a previously-coded access unit of the video data to the candidate list.

24. The device of claim 23, wherein the block in the first view in the previously-coded access unit comprises one of a spatially-neighboring block to a block or a spatially-neighboring block of the center block of a block in the first view in the previously coded access unit that is co-located relative to a location of the current block in the first view of the current access unit.

25. The device of claim 23, wherein N equals one of 1, 2, or 3.

26. The device of claim 19, wherein the at least three MVPs further comprise a temporal motion vector predictor (TMVP) derived from a block in the first view in a previously-coded access unit of the video data.

27. The device of claim 26, wherein the at least three MVPs further comprise a first spatial MVP derived from a first spatially-neighboring block to the current block in the first view of the current access unit, and a second spatial MVP derived from a second spatially-neighboring block to the current block in the first view of the current access unit.

28. The device of claim 19, wherein the video coder is further configured to:
after pruning, determine whether a number of MVPs in the candidate list is less than a length of the candidate list (N); and
when the number of MVPs in the candidate list is less than N, include one or more zero motion vector candidates as the end of the candidate list.

29. The device of claim 19, wherein the video coder is further configured to:
after pruning, determine whether a number of MVPs in the candidate list is greater than a length of the candidate list (N); and
when the number of MVPs in the candidate list is greater than N, remove one or more of the MVPs from the candidate list until the number of candidates is equal to N.

30. The device of claim 19, wherein the video coder is further configured to identify the block in the second view of the current access unit based on the disparity vector for the current block in the first view of the current access unit.

31. The device of claim 30, wherein the video coder is further configured to, when a reference picture index for the current block refers to the second view, set the IVMP equal to the disparity vector.

32. The device of claim 30, wherein the video coder is further configured to, when a reference picture index for the current block refers to a first temporal reference picture from a previously-coded access unit, and a motion vector for the block in the second view of the current access unit points to a second temporal reference picture from the same previously-coded access unit, set the IVMP for the current block to be a motion vector that points from the current block to a block in the first temporal reference picture and corresponds to the motion vector from the block in the second view of the current access unit to the second temporal reference picture.

33. The device of claim 19, wherein the video coder is configured to prune redundant ones of the at least three MVPs from the candidate list by at least removing one of the MVPs from the candidate list that is identical to another of the MVPs in the candidate list.

34. The device of claim 19, wherein the video coder comprises a video decoder that decodes the index into the candidate list of MVPs, and decodes the video data based on the one of the MVPs selected for the current block from the candidate list.

35. The device of claim 34, wherein including the at least three MVPs in the candidate list and pruning the at least one of the redundant MVPs comprises including the at least three MVPs in the candidate list and pruning the at least one of the redundant MVPs based on information received in a bitstream including the video data from a video encoder.

36. The device of claim 19, wherein the video coder comprises a video encoder that encodes the index into the candidate list of MVPs, and encodes the video data based on the one of the MVPs selected for the current block from the candidate list.

37. The device of claim 19, wherein the device comprises at least one of:
an integrated circuit implementing the video coder;
a microprocessor implementing the video coder; and
a wireless communication device including the video coder.

38. A device comprising:
means for including at least three motion vector predictors (MVPs) in a candidate list of MVPs for a current block in a first view of a current access unit of the video data, wherein the at least three MVPs comprise an inter-view motion vector predictor (IVMP), and wherein the IVMP is one of derived from a block in a second view of the current access unit or converted from a disparity vector for the current block in the first view of the current access unit;
means for, when there are one or more redundant MVPs among the at least three MVPs in the candidate list, pruning at least one of the redundant MVPs from the candidate list;
means for coding an index into the candidate list of MVPs, the index referencing one of the MVPs from the candidate list for the current block; and
means for coding the video data based on the one of the MVPs from the candidate list selected for the current block.

39. The device of claim 38, wherein the at least three MVPs further comprise a first spatial MVP derived from a first spatially-neighboring block to the current block in the first view of the current access unit, and a second spatial MVP derived from a second spatially-neighboring block to the current block in the first view of the current access unit.

40. The device of claim 38, further comprising:
means for, after pruning redundant ones of the MVPs from the candidate list, determining whether a number of MVPs in the candidate list is less than a predetermined length (N) of the candidate list; and
means for, when the number of MVPs in the candidate list is less than N, adding a temporal motion vector predictor (TMVP) derived from a block in the first view in a previously-coded access unit of the video data to the candidate list.

41. The device of claim 38, wherein the at least three MVPs further comprise a temporal motion vector predictor (TMVP) derived from a block in the first view in a previously-coded access unit of the video data.

42. The device of claim 41, wherein the at least three MVPs further comprise a first spatial MVP derived from a first spatially-neighboring block to the current block in the first view of the current access unit, and a second spatial MVP derived from a second spatially-neighboring block to the current block in the first view of the current access unit.

43. The device of claim 38, further comprising means for identifying the block in the second view of the current access unit based on the disparity vector for the current block in the first view of the current access unit.

44. The device of claim 43, further comprising means for, when a reference picture index for the current block refers to the second view, setting the IVMP equal to the disparity vector.

45. The device of claim 43, further comprising means for, when a reference picture index for the current block refers to a first temporal reference picture from a previously-coded access unit, and a motion vector for the block in the second view of the current access unit points to a second temporal reference picture from the same previously-coded access unit, setting the IVMP for the current block to be a motion vector that points from the current block to a block in the first temporal reference picture and corresponds to the motion vector from the block in the second view of the current access unit to the second temporal reference picture.

46. A computer-readable storage medium having instructions stored thereon that, when executed by one or more processors of a video coder, cause the video coder to:
include at least three motion vector predictors (MVPs) in a candidate list of MVPs for a current block in a first view of a current access unit of the video data, wherein the at least three MVPs comprise an inter-view motion vector predictor (IVMP), and wherein the IVMP is one of derived from a block in a second view of the current access unit or converted from a disparity vector for the current block in the first view of the current access unit;
when there are one or more redundant MVPs among the at least three MVPs in the candidate list, prune at least one of the redundant MVPs from the candidate list;
code an index into the candidate list of MVPs, the index referencing one of the MVPs from the candidate list for the current block; and
coding the video data based on the one of the MVPs from the candidate list selected for the current block.

47. The computer-readable storage medium of claim 46, wherein the at least three MVPs further comprise a first spatial MVP derived from a first spatially-neighboring block to the current block in the first view of the current access unit, and a second spatial MVP derived from a second spatially-neighboring block to the current block in the first view of the current access unit.

48. The computer-readable storage medium of claim 46, further comprising:
after pruning redundant ones of the MVPs from the candidate list, determining whether a number of MVPs in the candidate list is less than a predetermined length (N) of the candidate list; and
when the number of MVPs in the candidate list is less than N, adding a temporal motion vector predictor (TMVP) derived from a block in the first view in a previously-coded access unit of the video data to the candidate list.

49. The computer-readable storage medium of claim 46, wherein the at least three MVPs further comprise a temporal motion vector predictor (TMVP) derived from a block in the first view in a previously-coded access unit of the video data.

50. The computer-readable storage medium of claim 49, wherein the at least three MVPs further comprise a first spatial MVP derived from a first spatially-neighboring block to the current block in the first view of the current access unit, and a second spatial MVP derived from a second spatially-neighboring block to the current block in the first view of the current access unit.

51. The computer-readable storage medium of claim 46, further comprising identifying the block in the second view of the current access unit based on the disparity vector for the current block in the first view of the current access unit.

52. The computer-readable storage medium of claim 51, further comprising, when a reference picture index for the current block refers to the second view, setting the IVMP equal to the disparity vector.

53. The computer-readable storage medium of claim 51, further comprising, when a reference picture index for the current block refers to a first temporal reference picture from a previously-coded access unit, and a motion vector for the block in the second view of the current access unit points to a second temporal reference picture from the same previously-coded access unit, setting the IVMP for the current block to be a motion vector that points from the current block to a block in the first temporal reference picture and corresponds to the motion vector from the block in the second view of the current access unit to the second temporal reference picture.

54. A method of coding video data, the method comprising:
including, in a first list of motion vector predictors (MVPs) for a current block in a first view of a current access unit of the video data, a first spatial MVP derived from a first spatially-neighboring block to the current block in the first view of the current access unit, and a second spatial MVP derived from a second spatially-neighboring block to the current block in the first view of the current access unit;
when the second spatial MVP is redundant over the first spatial MVP, pruning one of the first and second spatial MVPs from the first list of MVPs;
including, in a second list of MVPs for the current block, an inter-view motion vector predictor (IVMP) that is one of derived from a block in a second view of the current access unit or converted from a disparity vector for the current block in the first view of the current access unit, and a temporal motion vector predictor (TMVP) derived from a block in the first view in a previously-coded access unit of the video data;
when the TMVP is redundant over the IVMP, pruning one of the IVMP and TMVP from the second list of MVPs;
combining MVPs remaining in the first and second lists to form a candidate list of MVPs
coding an index into the candidate list of MVPs, the index referencing one of the MVPs from the candidate list for the current block; and
coding the video data based on the one of the MVPs from the candidate list selected for the current block.

55. The method of claim 54, wherein combining comprises adding the MVPs remaining in the first list to the candidate list, and then adding the MVPs remaining in the second list to the candidate list.

56. The method of claim 54, wherein combining comprises adding the MVPs remaining in the second list to the candidate list, and then adding the MVPs remaining in the first list to the candidate list.

57. A method of coding video data, the method comprising:
including, in a candidate list of motion vector predictors (MVPs) for a current block in a first view of a current access unit of the video data, a first spatial MVP derived from a first spatially-neighboring block to the current block in the first view of the current access unit, and a second spatial MVP derived from a second spatially-neighboring block to the current block in the first view of the current access unit, wherein a predetermined length (N) of the candidate list is equal to two;
when the second spatial MVP is redundant over the first spatial MVP:
removing one of the first and second spatial MVPs from the candidate list, and
adding an inter-view motion vector predictor (IVMP)), and wherein the IVMP is one of derived from a block in a second view of the current access unit or converted from a disparity vector for the current block in the first view of the current access unit;
coding an index into the candidate list of MVPs, the index referencing one of the MVPs from the candidate list for the current block; and
coding the video data based on the one of the MVPs from the candidate list selected for the current block
